(19) United States
(12) Patent Application Publication
(10) Pub. No.: US 2003/0164058 A1
(43) Pub. Date: Sep. 4, 2003

(54) Brake pedal designed to equip a motor vehicle

(76) Inventors: Franck Sauvonnet, Fontenay Sous Bois (FR); Brian N. Orr, Chesterfield Township, MI (US); Waldemar W. Gmurowski, Sterling Heights, MI (US)

Correspondence Address: Gary M Cohen, Strafford Building Number Three, Suite 300, 125 Strafford Avenue, Wayne, PA, 19087, US

(21) Appl. No.: 10/297,034

(22) PCT Filed: Feb. 18, 2002
(86) PCT No.: PCT/FR02/00604

(30) Foreign Application Priority Data
Feb. 19, 2001 (FR) 01/02216

(51) Int. Cl. G05G 1/14

(52) U.S. Cl. 74/512

(57) ABSTRACT

The invention relates to a brake pedal (1) intended to equip a vehicle, particularly a motor vehicle, comprising a framework structure (2) mounted to rotate about a first rotation spindle (3) designed to be connected to the bulkhead of the vehicle, a pedal web (4) to one end (4a) of which is fixed a peg (5) designed to slide in a slot (21) made in the framework structure (2), a movement mechanism (7) to cause the peg to slide in the slot, defining a length (L) between the rotation spindle of the framework structure and the other end (4b) of the pedal web, a first link (8) connected to the framework structure and mounted to rotate about a second rotation spindle (9) designed to be connected to the bulkhead of the vehicle, a connection (13) designed to receive the end of the rod of the brake booster at a distance (R) from the second rotation spindle.

According to the invention, this pedal comprises means (13, 14, 16, 17) for obtaining a constant step-down ratio (L/R).

The present invention relates to a brake pedal intended to equip a vehicle, particularly a motor vehicle, comprising a framework structure mounted to rotate about a first rotation spindle designed to be connected to the bulkhead of the vehicle, a pedal web to one end of which is fixed a peg designed to slide in a slot made in the framework structure, a movement mechanism to cause the peg to slide in the slot, defining a length (L) between the rotation spindle of the framework structure and the other end of the pedal web, a first link connected to the framework structure and mounted to rotate about a second rotation spindle designed to be connected to the bulkhead of the vehicle, a connection designed to receive the end of the rod of the brake booster at a distance (R) from the second rotation spindle.

It is known practice for adjustable pedalboxes to be fitted in motor vehicles and some are currently used in vehicles equipped with automatic gearboxes and controlled from a control unit accessible from the driving position. The term “adjustable” means that all or part of the pedalbox can be moved closer to or away from the driver's seat in the lengthwise direction of the vehicle so that it is possible to tailor the position of at least part of the pedalbox to the position of the driver's seat and therefore to his size.

In particular, it is known practice in vehicles equipped with mechanical gearboxes for there to be brake pedals which can be adjusted to suit the size of the driver.

Thus, brake pedals of the type mentioned in the preamble are known. This type of brake pedal is not entirely satisfactory, particularly for small drivers.

What happens is that once the pedal has been adjusted, the braking effected by the driver is not necessarily strong enough to be able to brake the vehicle correctly because the working travel of the pedal is not compensated for and the service braking force.

The object of the present invention is therefore to propose a brake pedal of the type mentioned hereinabove, the useful travel of which can be compensated for regardless of its position.

To achieve this, the subject of the invention is a brake pedal intended to equip a vehicle, particularly a motor vehicle, [lacuna] a framework mounted to rotate about a first rotation spindle designed to be connected to the bulkhead of the vehicle, a pedal web to one end of which is fixed a peg designed to slide in a slot made in the framework structure, a movement mechanism to cause the peg to slide in the slot, defining a length (L) between the rotation spindle of the framework structure and the other end of the pedal web, a first link connected to the framework structure and mounted to rotate about a second rotation spindle designed to be connected to the bulkhead of the vehicle, a connection designed to receive the end of the rod of the brake booster at a distance (R) from the second rotation spindle, characterized in that this pedal comprises means for obtaining a constant step-down ratio (L/R).

According to a preferred embodiment, the means for obtaining a constant step-down ratio (L/R) comprise a nut mounted to slide on a worm secured to one end of the link and designed to receive the end of the rod of the brake booster.

According to another advantageous feature, the movement mechanism comprises an angled reduction gearbox coupled to a worm on which a nut secured to the pedal web can slide.

As a preference, the worm and the angled reduction gearbox are fixed to one of the faces of the framework structure.

Also preferably, the other end of the first link is secured, via a pivot connection, to a second link itself secured to the framework structure.

Advantageously, the ratio between the size of the nut and that of the worm of the means for obtaining the constant step-down ratio can be modified as the driver wishes. It is thus possible for the driver to have a relationship between the pedal travel and the force applied to it that is tailored to the driver's build.

The invention also relates to a pedalbox module, intended to be fitted in a motor vehicle, comprising a pedal as claimed in one of the preceding claims.

This module advantageously comprises a clutch pedal comprising a movement mechanism making it possible to achieve the same spatial movement as is achieved with the brake pedal.

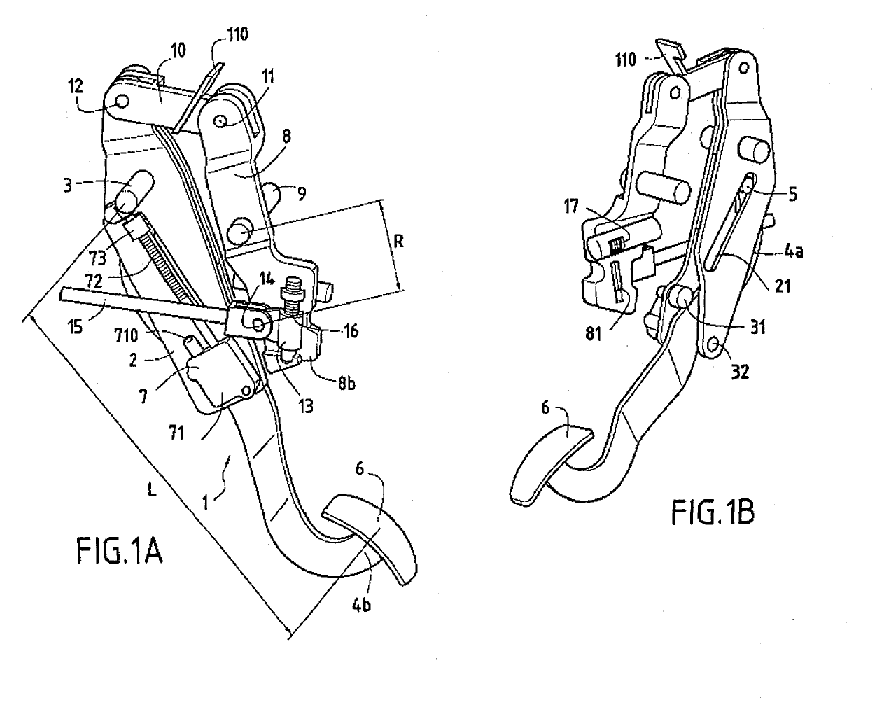

Other advantages and features will become better apparent from reading the detailed description below given with reference to FIGS. 1a and 1b which, respectively, depict a view from each of the sides of a brake pedal according to the invention.

As depicted, the brake pedal 1 first of all comprises a framework structure 2 mounted to rotate about a rotation spindle 3 mounted on a pedalbox support, not depicted, on which a clutch pedal is also mounted. This support is designed to be connected to the bulkhead of a motor vehicle, not depicted here.

The framework structure 2 in its lower part comprises rollers 31, 32 between which a pedal web 4 can slide.

Fixed to the upper end 4a of this pedal web 4 is a peg 5 designed to slide in a slot 21 made in the framework structure 2. Fixed to the lower end 4b of the pedal web 4 is a block 6 of a shape known per se and of a size suited to the vehicle.

A movement mechanism 7 is provided on the outer face of the framework structure 2, to cause the peg 5 to slide in the slot 21, defining a length (L) between the rotation spindle 3 of the side plate and the lower end 4b of the pedal web 4 approximately at the middle of the block 6. This mechanism 7 comprises an angled reduction gearbox 71 coupled to a worm 72 on which a nut 73 secured to the pedal web 4 can slide. The angled reduction gearbox 71 consists of a gearset known per se and not depicted here. Its input 710 is connected to an electric motor via a transmission cable known per se. This electric motor is advantageously, for cost and space reasons, the one which powers the other mechanisms for moving the other pedals.

The brake pedal 1 also comprises a a first link 8 mounted to rotate about a second rotation spindle 9 designed to be connected to the bulkhead of the vehicle.

A second link 10 is fixed to the upper end 8a of this link 8 by a pivot connection 11. This second link 10 is itself fixed to the framework structure 2 by another pivot connection 12. This second link 10 also comprises a hook 110 designed to trigger contact switches such as those which trigger the brake lights or which provide information to the computer.

Fixed to the lower end 8b of this link 8 is a connection 13 in the form of a nut to which there is fixed, by means of a clevis 14, the end of the hydraulic rod 15 of the brake booster, not depicted, at a distance (R) from the second rotation spindle 9.

This nut 13 is mounted to slide on a worm 16 fixed in a slit 81 made in the first link 8. This worm 16 can be driven by another worm 17 mounted in a housing made in the first link 8. The free end of the worm 17 can be driven by a transmission cable, not depicted, connected to an electric motor which also powers the angled reduction gearbox 71.

The clevis 14 is distant from the second rotation spindle 9 by a distance (R) which varies therefore as a function of the location of the nut 13 on the worm 16.

The way in which the brake pedal 1 just described and equipping a vehicle works will now be explained.

When the driver of the vehicle gets into the latter, he adjusts the position of the brake pedal 1 by actuating the electric motor connected to the angled reduction gearbox 71. The latter transmits a rotational movement to the worm 72, which moves the nut 73 parallel to the framework structure 2. The peg 5 of the pedal web 4 therefore slides in the slot 21, and this causes the length (L) between the lower end 4b of the pedal web 4 and the rotation spindle 3 to vary. The motor is actuated until a length (Lo) corresponding to a satisfactory driving position for the driver is reached.

At the same time, the electric motor, via the transmission cable, drives the worm 17 which in turn drives the worm 16 on the nut 13 slides until the distance (R) is modified to reach the value (Ro) so that the ratio (Lo/Ro) is equal to the initial ratio. Thus, the brake pedal 1 has a step-down ratio (L/R) that remains constant regardless of its position with respect to the bulkhead, that is to say regardless of its travel. As far as the driver is concerned this is manifested in a constant force to be applied.

It goes without saying that numerous modifications of details may be made without thereby departing from the scope of the invention.

1. A brake pedal (1) intended to equip a vehicle, particularly a motor vehicle, comprising a framework structure (2) mounted to rotate about a first rotation spindle (3) designed to be connected to the bulkhead of the vehicle, a pedal web (4) to one end (4a) of which is fixed a peg (5) designed to slide in a slot (21) made in the framework structure (2), a movement mechanism (7) to cause the peg to slide in the slot, defining a length (L) between the rotation spindle of the framework structure and the other end (4b) of the pedal web, a first link (8) connected to the framework structure and mounted to rotate about a second rotation spindle (9) designed to be connected to the bulkhead of the vehicle, a connection (13) designed to receive the end of the rod of the brake booster at a distance (R) from the second rotation spindle, characterized in that this pedal comprises means (13, 14, 16, 17) for obtaining a constant step-down ratio (L/R).

2. The brake pedal as claimed in claim 1, characterized in that the means for obtaining a constant step-down ratio (L/R) comprise a nut (13) mounted to slide on a worm (16) secured to one end of the link and designed to receive the end of the rod of the brake booster.

3. The pedal as claimed in claim 1 or 2, characterized in that the movement mechanism (7) comprises an angled reduction gearbox (71) coupled to a worm (72) on which a nut (73) secured to the pedal web can slide.

4. The pedal as claimed in claim 3, characterized in that the worm (72) and the angled reduction gearbox (71) are fixed to one of the faces of the framework structure.

5. The pedal as claimed in one of the preceding claims, characterized in that the other end of the first link is secured, via a pivot connection (11), to a second link (10) itself secured to the framework structure.

6. The pedal as claimed in one of the preceding claims, characterized in that the ratio between the size of the nut and that of the worm of the means for obtaining the constant step-down ratio can be modified as the driver wishes.

7. A pedalbox module, intended to be fitted in a motor vehicle, comprising a pedal as claimed in one of the preceding claims.

8. The module as claimed in claim 7, characterized in that it comprises a clutch pedal comprising a movement mechanism making it possible to achieve the same spatial movement as is achieved with the brake pedal.
